(19) United States
(12) Patent Application Publication
(10) Pub. No.: US 2015/0245442 A1
(43) Pub. Date: Aug. 27, 2015

(54) LOW-FLICKERLIGHT-EMITTING DIODE LIGHTING DEVICE HAVING MULTIPLE DRIVING STAGES

(71) Applicant: IML International, Grand Cayman (KY)

(72) Inventors: Horng-Bin Hsu, Taipei City (TW); Yi-Mei Li, New Taipei City (TW); Yung-Hsin Chiang, New Taipei City (TW)

(21) Appl. No.: 14/700,165

(22) Filed: Apr. 30, 2015

Related U.S. Application Data
(63) Continuation-in-part of application No. 14/267,916, filed on May 2, 2014, now Pat. No. 9,084,315.
(60) Provisional application No. 61/991,627, filed on May 12, 2014.
(60) Provisional application No. 61/844,438, filed on Jul. 10, 2013.

(51) Int. Cl. H05B 33/08

(52) U.S. Cl. CPC H05B 33/0851; H05B 33/0809

(57) ABSTRACT

An LED lighting device includes multiple luminescent devices driven by a rectified AC voltage. The multiple luminescent devices are turned on flexibly in a multi-stage driving scheme using multiple current control units. At least one charge storage unit is coupled in parallel with at least one luminescent device. When the rectified AC voltage is still insufficient to turn on the at least one luminescent device, the at least charge storage unit is configured to discharge energy to the at least one luminescent device, thereby keeping the at least one luminescent device turned on.

### CROSS REFERENCE TO RELATED APPLICATIONS

This application is a Continuation in Part of U.S. non-provisional application Ser. No. 14/267,916 filed on May 2, 2014 which claims the benefit of U.S. provisional application No. 61/844,438 filed on Jul. 10, 2013. This application claims the benefit of U.S. provisional application No. 61/991,627 filed on May 12, 2014.

### BACKGROUND OF THE INVENTION

1. Field of the Invention

The present invention is related to an LED lighting device having multiple driving stages, and more particularly, to an LED lighting device having multiple driving stages for providing wide effective operational voltage range without causing flicker and uniformity issue.

2. Description of the Prior Art

An LED lighting device directly driven by a rectified alternative-current (AC) voltage usually adopts a plurality of LEDs coupled in series in order to provide required luminance. As the number of the LEDs increases, a higher forward-bias voltage is required for turning on the LED lighting device, thereby reducing the effective operational voltage range of the LED lighting device. As the number of the LEDs decreases, the large driving current when the rectified voltage is at its maximum level may impact the reliability of the LEDs.

An LED lighting device is configured to modulate luminous flux and intensity. This time variation is commonly referred to as flicker. LED flicker, whether perceptible or not, has been a concern of the lighting community because of its potential human impacts, which range from distraction, mild annoyance to neurological problems. Therefore, there is a need for an LED lighting device capable of improving the effective operational voltage range, the reliability and the flicker phenomenon.

### SUMMARY OF THE INVENTION

The present invention provides an LED lighting device having a first driving stage and a second driving stage. The first driving stage includes a first luminescent device driven by a rectified AC voltage for providing light according to first current; a second luminescent device driven by the rectified AC voltage for providing light according to second current; a first current controller coupled in series to the first luminescent device and configured to regulate the first current so that the first current does not exceed a first value; a second current controller coupled in series to the second luminescent device and configured to regulate the second current so that the second current does not exceed a second value; a first charge storage unit coupled in parallel with at least the first luminescent device and configured to discharge energy to the first luminescent device when the rectified AC voltage is insufficient to turn on the first luminescent device, thereby keeping the first luminescent device turned on; and a path-controller configured to conduct third current and having a first end coupled between the first luminescent device and the first current controller and a second end coupled to the second current controller. The second driving stage includes a third current controller coupled in series to the first driving stage and configured to conduct fourth current and regulate the fourth current so that the fourth current does not exceed a third value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1˜4 are diagrams of LED lighting devices according to embodiments of the present invention.

FIGS. 5˜9 are diagrams illustrating the operation of the multiple driving stages in the LED lighting device of the present invention.

FIG. 10 is a diagram illustrating the current-time characteristic of the luminescent device in the LED lighting device of the present invention.

FIG. 11 is a diagram illustrating the overall operation of an LED lighting device according to embodiments of the present invention.

FIG. 12 is a diagram illustrating the overall operation of an LED lighting device.

FIGS. 13˜16 are diagrams of LED lighting devices according to other embodiments of the present invention.

### DETAILED DESCRIPTION

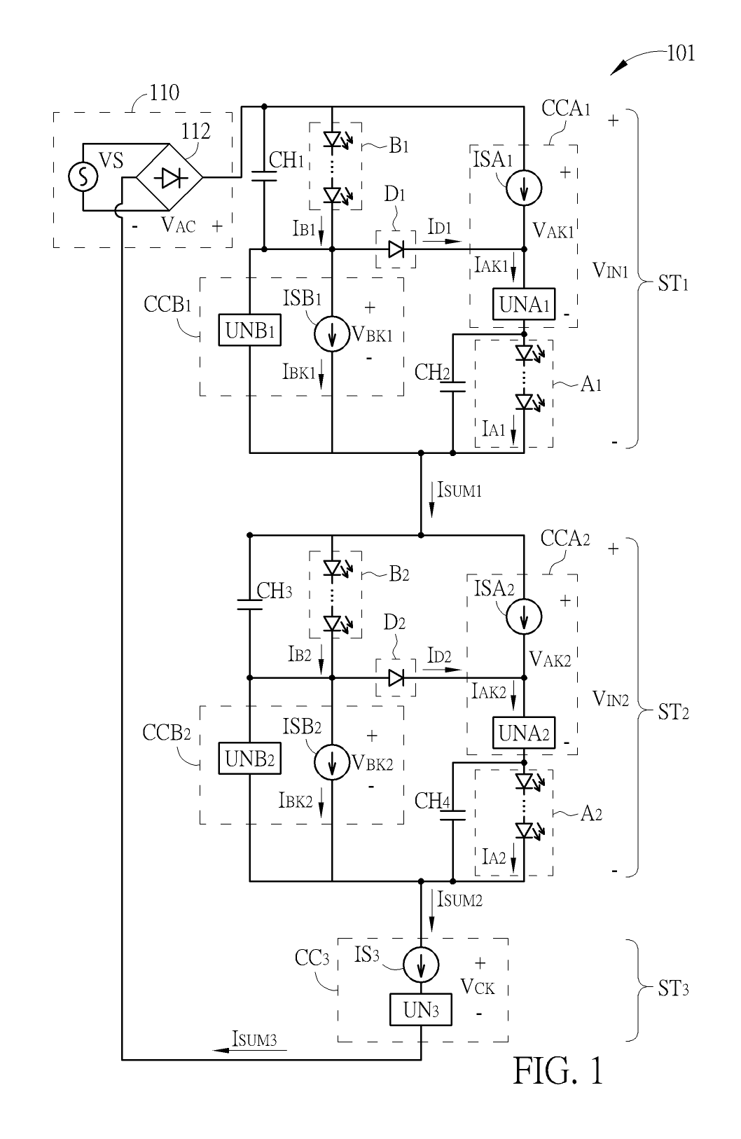

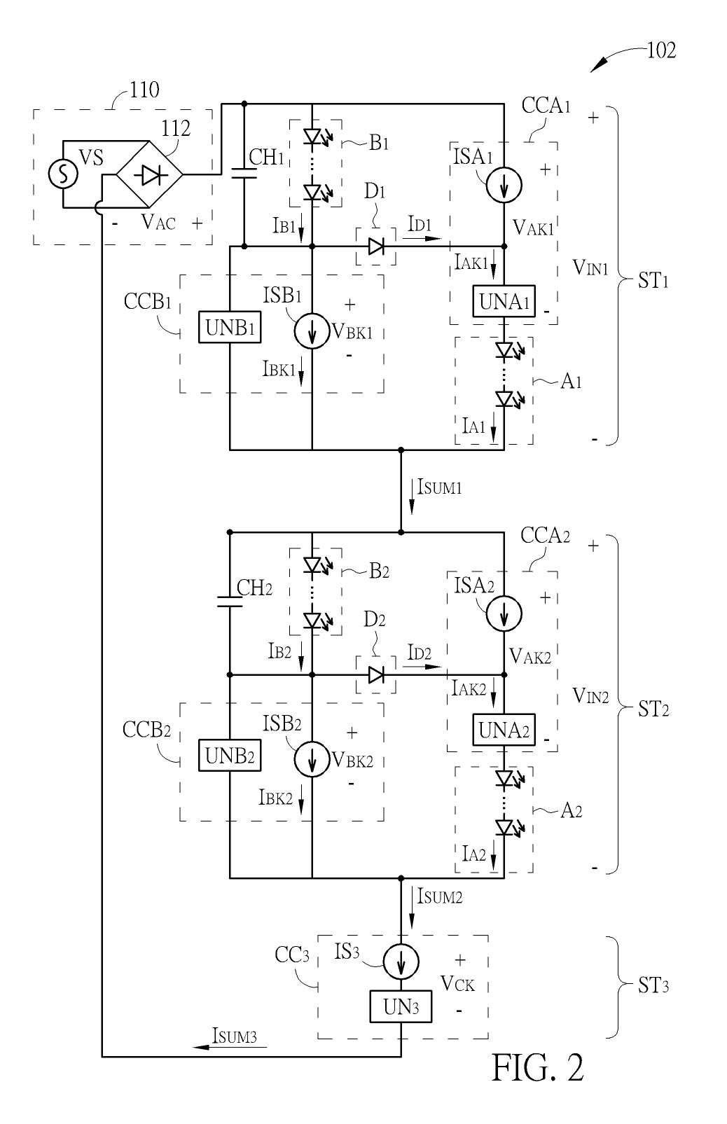

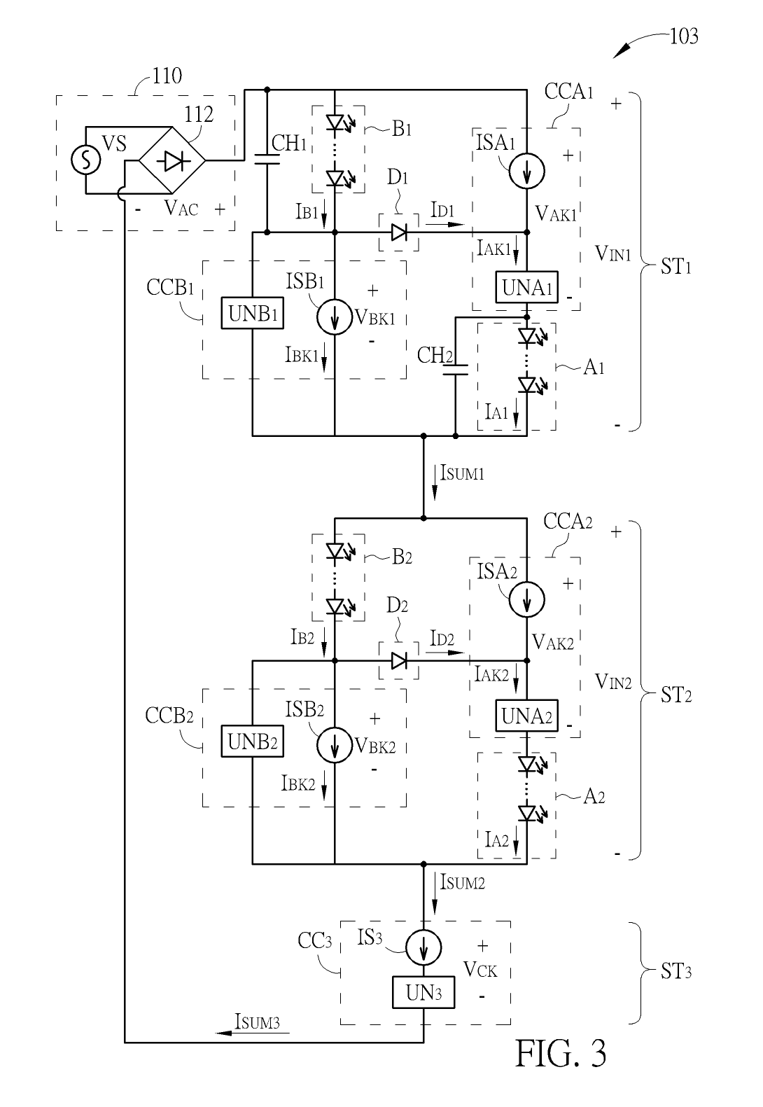

FIGS. 1-4 are diagrams of LED lighting devices 101-104 according to embodiments of the present invention. Each of the LED lighting devices 101-104 includes a power supply circuit 110 and (N+1) driving stages ST₁˜ST_{N+1}. The power supply circuit 110 is configured to receive an AC voltage VS having positive and negative periods and convert the output of the AC voltage VS in the negative period using a bridge rectifier 112, thereby providing a rectified AC voltage V_{AC}, whose value varies periodically with time, for driving the (N+1) driving stages. In another embodiment, the power supply circuit 110 may receive any AC voltage VS, perform voltage conversion using an AC-AC converter, and rectify the converted AC voltage VS using the bridge rectifier 112, thereby providing the rectified AC voltage V_{AC}, whose value varies periodically with time. The configuration of the power supply circuit 110 does not limit the scope of the present invention.

In the LED lighting devices 101˜103, each of the 1^{st} to N^{th} driving stages ST₁˜ST_{N} includes a plurality of luminescent devices, a path controller, a first-type current controller, a second-type current controller, and M charge storage units CH₁˜CH_{M}, wherein N is a positive integer larger than 1, and M is a positive integer smaller or equal to 2N. The (N+1)^{th} driving stage ST_{N+1} includes a third-type current controller.

In the LED lighting device 104, the 1^{st}₁ driving stage ST₁ includes a plurality of luminescent devices, while each of the 2^{nd} to N^{th} driving stages ST₂˜ST_{N} includes a plurality of luminescent devices, a path controller, a first-type current controller, a second-type current controller, and M charge storage units CH₁˜CH_{M}, wherein N is a positive integer larger than 1, and M is a positive integer smaller or equal to 2N. The (N+1)^{th} driving stage ST_{N+1} includes a third-type current controller.

Each first-type current controller includes an adjustable current source and a current detection and control unit. Each second-type current controller includes an adjustable current source and a voltage detection and control unit. The third-type current controller includes an adjustable current source and a detection and control unit.

For illustrative purposes, the following symbols are used to represent each device in the LED lighting devices 101-104 throughout the description and figures. A₁˜A_{N} and B₁˜B_{N} represent the luminescent devices in the corresponding driving stages ST₁˜ST_{N}, respectively. D₁˜D_{N} represent the path-controllers in the corresponding driving stages ST₁˜ST_{N}, respectively. CCA₁˜CCA_{N} represent the first-type current controllers in the corresponding driving stages ST₁˜ST_{N}, respectively. CCB₁˜CCB_{N} represent the second-type current controllers in the corresponding driving stages ST₁˜ST_{N}, respectively. CC_{N+1} represents the third-type current controller in the (N+1)^{th} driving stage ST_{N+1}. ISA₁˜ISA_{N} represent the adjustable current sources in the corresponding first-type current controllers CCA₁˜CCA_{N}, respectively. ISB₁˜ISB_{N} represent the adjustable current sources in the corresponding second-type current controllers CCB₁˜CCB_{N}, respectively. IS_{N+1} represents the adjustable current source in the third-type current controller CC_{N+1}. UNA₁˜UNA_{N} represent the current detection and control units in the corresponding first-type current controllers CCA₁˜CCA_{N} respectively. UNB₁˜UNB_{N} represent the voltage detection and control units in the corresponding second-type current controllers CCB₁˜CCB_{N}, respectively. UN_{N+1} represents the detection and control unit in the (N+1)^{th} driving stage ST_{N+1}.

For illustrative purposes, the following symbols are used to represent related current/voltage in the LED lighting devices 101˜104 throughout the description and figures. V_{IN1}˜V_{INN} represent the voltages established across the 1^{st} to N^{th} driving stages ST₁˜ST_{N}, respectively. V_{AK1}˜V_{AKN} represent the voltages established across the corresponding first-type current controllers CCA₁˜CCA_{N}, respectively. V_{BK1}˜V_{BKN} represent the voltages established across the corresponding second-type current controllers CCB₁˜CCB_{N}, respectively. V_{CK} represents the voltage established across the third-type current controller CC_{N+1}. I_{AK1}˜I_{AKN} represent the current flowing through the corresponding first-type current controllers CCA₁˜CCA_{N}, respectively. I_{BK1}˜I_{BKN} represent the current flowing through the corresponding second-type current controllers CCB₁˜CCB_{N}, respectively. I_{A1}˜I_{AN} represent the current flowing through the corresponding luminescent devices A₁˜A_{N}, respectively. I_{B1}˜I_{BN} represent the current flowing through the corresponding luminescent devices B₁˜B_{N}, respectively. I_{D1}˜I_{DN} represent the current flowing through the corresponding path controllers D₁˜D_{N}, respectively. I_{SUM1}˜I_{SUMN} represent the current flowing through the corresponding driving stages ST₁˜ST_{N}, respectively. The overall current of the LED lighting devices 101˜104 may be represented by I_{SUM(N+1)}.

In the 1^{st} to N^{th} driving stages ST₁˜ST_{N} of the LED lighting devices 101˜103, the current detection and control units UNA₁˜UNA_{N}, respectively coupled in series to the corresponding luminescent devices A₁˜A_{N} and the corresponding adjustable current sources ISA₁˜ISA_{N}, are configured to regulate the values of the adjustable current sources ISA₁˜ISA_{N} according the current I_{AK1}˜I_{AKN}, respectively. The voltage detection and control units UNB₁˜UNB_{N}, respectively coupled in series to the corresponding luminescent devices B₁˜B_{N} and in parallel with the corresponding adjustable current sources ISB₁˜ISB_{N}, are configured to regulate the values of the adjustable current sources ISB₁˜ISB_{N} according the voltages V_{BK1}˜V_{BKN} respectively.

In the 2^{nd} to N^{th} driving stages ST₂˜ST_{N} of the LED lighting device 104, the current detection and control units UNA₂˜UNA_{N} respectively coupled in series to the corresponding luminescent devices A₂˜A_{N} and the corresponding adjustable current sources ISA₂˜ISA_{N}, are configured to regulate the values of the adjustable current sources ISA₂˜ISA_{N} according the current I_{AK2}˜I_{AKN}, respectively. The voltage detection and control units UNB₂˜UNB_{N}, respectively coupled in series to the corresponding luminescent devices B₂˜B_{N} and in parallel with the corresponding adjustable current sources ISB₂˜ISB_{N}, are configured to regulate the values of the adjustable current sources ISB₂˜ISB_{N} according the voltages V_{BK2}˜V_{BKN} respectively.

In the (N+1)^{th} driving stage ST_{N+1} of the LED lighting devices 101˜104, the adjustable current source IS_{N+1} is coupled in series to the 1^{st} to N^{th} driving stages ST₁˜ST_{N}. In a first configuration, the detection and control unit UN_{N+1} of the third-type current controller CC_{N+1} may be coupled in series to the adjustable current source IS_{N+1} and is configured to regulate the value of the adjustable current source IS_{N+1} according the current I_{SUMN}. In a second configuration, the detection and control unit UN_{N+1} of the third-type current controller CC_{N+1} may be coupled in parallel with the adjustable current source IS_{N+1} and is configured to regulate the value of the adjustable current source IS_{N+1} according the voltage V_{CK}. FIGS. 1˜4 depict the embodiments adopting the first configuration, but do not limit the scope of the present invention.

In the embodiment of the present invention, each of the luminescent devices A₁˜A_{N} and B₁˜B_{N} may adopt a single LED or multiple LEDs coupled in series. FIGS. 1-4 depict the embodiments using multiple LEDs which may consist of single-junction LEDs, multi-junction high-voltage (HV) LEDs, or any combination of various types of LEDs. However, the types and configurations of the luminescent devices A₁˜A_{N} and B₁˜B_{N} do not limit the scope of the present invention. In a specific driving stage, the dropout voltage V_{DROP} for turning on the corresponding current controller is smaller than the cut-in voltage V_{CUT} for turning on the corresponding luminescent device. When the voltage established across a specific luminescent device exceeds its cut-in voltage V_{CUT}, the specific luminescent device may be placed in a conducting ON state; when the voltage established across the specific luminescent device does not exceed its cut-in voltage V_{CUT}, the specific luminescent device may be placed in a non-conducting OFF state. The value of the cut-in voltage V_{CUT} is related to the number or type of the LEDs in the corresponding luminescent device and may vary in different applications.

In the embodiment of the present invention, each of the M charge storage units CH₁˜CH_{M} may adopt a capacitor, or one or multiple devices which provides similar function. However, the types and configurations of the charge storage units CH₁˜CH_{M} do not limit the scope of the present invention.

In the embodiment of the present invention, each of the path-controllers D₁˜D_{N} may adopt a diode, a diode-connected field effect transistor (FET), a diode-connected bipolar junction transistor (BJT) or other devices having similar function, or one or multiple devices which provides similar function. However, the types and configurations of the path controllers D₁˜D_{N} do not limit the scope of the present invention. When the voltage established across a specific path controller exceeds its turn-on voltage, the specific path controller is forward-biased and functions as a short-circuited device; when the voltage established across the specific path controller does not exceed its turn-on voltage, the specific path controller is reverse-biased and functions as an open-circuited device.

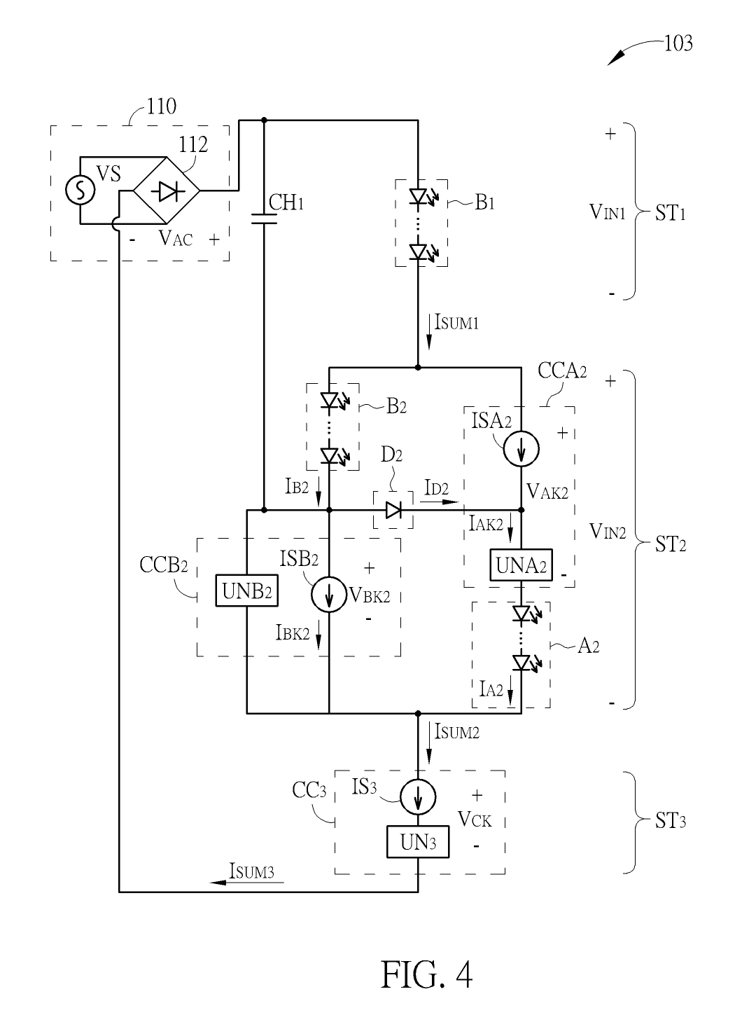

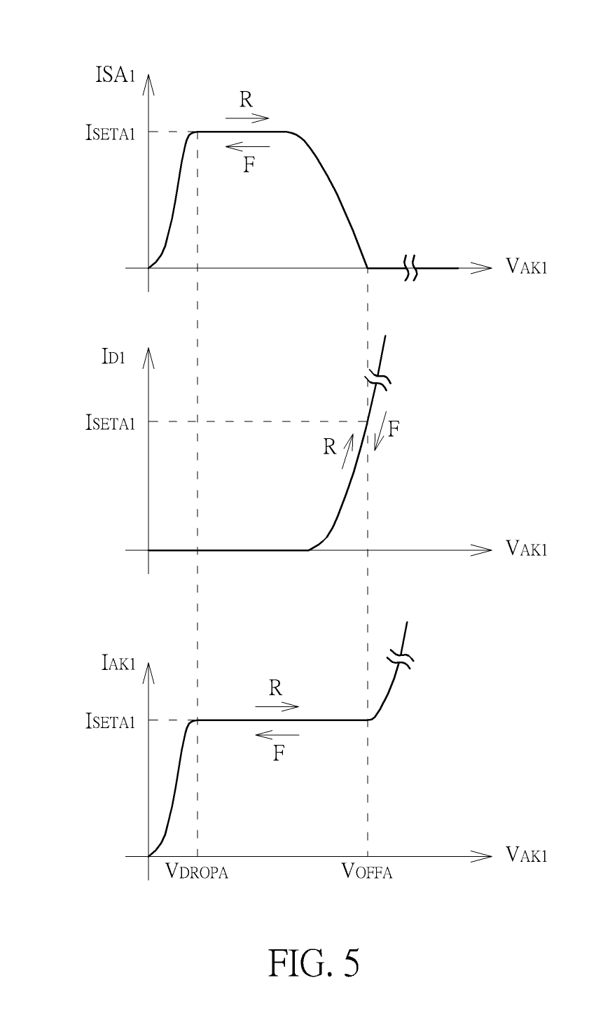

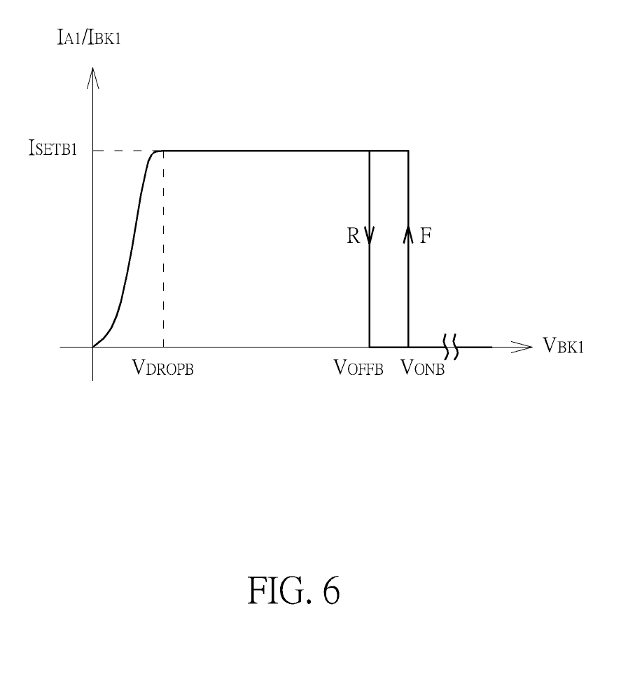

FIGS. 5˜8 are diagrams illustrating the operation of the 1^{st} to N^{th} driving stages ST₁˜ST_{N} in the LED lighting devices 101-103 according to embodiments of the present invention. The driving stage ST₁ in the LED lighting devices 101-103 is used for illustrative purpose, wherein FIG. 5 illustrates the current-voltage curve (I-V curve) of the first-type current controller CCA₁, FIG. 6 illustrates the I-V curve of the second-type current controller CCB₁, FIG. 7 illustrates the equivalent circuits of the 1^{st} driving stage ST₁ during different phases of operation, and FIG. 8 illustrates the I-V curve of the 1^{st} driving stage ST₁. FIG. 9 is a diagram illustrating the operation of the current controller CC_{N+1} in the (N+1)^{th} driving stages ST_{N+1} of the LED lighting devices 101-104. V_{DROPA}, V_{DROPB} and V_{DROPC} represent the drop-out voltages for turning on the first-type current controller CCA₁, the second-type current controller CCB₁ and the third-type current controller CC_{N+1}, respectively. V_{OFFA}, V_{OFFB} and V_{ONB} represent the threshold voltages based on which the first-type current controller CCA₁ or the second-type current controller CCB₁ switch operational modes. I_{SETA1}, I_{SETB1} and I_{SETC} are constant values which represent the current settings of the first-type current controller CCA₁, the second-type current controller and the third-type current controller CC_{N+1}, respectively. An arrow R indicates the rising period of the voltage V_{AK1}, V_{BK1} or V_{CK}. An arrow L indicates the falling period of the voltage V_{AK1}, V_{BK1} or V_{CK}.

In FIG. 5, during the rising and falling periods of the voltage V_{AK1} when 0<V_{AK}1<V_{DROPA}, the first-type current controller CCA₁ is not completely turned on and operates as a voltage-controlled device in a linear mode in which the current I_{AK1} changes with the voltage V_{AK1} in a specific manner. For example, if the first-type current controller CCA₁ is implemented using metal-oxide-semiconductor (MOS) transistors, the relationship between the current I_{AK1} and the voltage V_{AK1} may correspond to the I-V characteristic of an MOS transistor when operating in the linear region.

During the rising and falling periods of the voltage V_{AK1} when V_{AK1}>V_{DROPA}, the current I_{AK1} reaches I_{SETA1}, and the first-type current controller CCA₁ switches to a constant-current mode and functions as a current limiter. The current detection and control unit UNA₁ is configured to clamp the current I_{AK1} at I_{SETA1}. For example, in response to an increase in the current I_{D1}, the current detection and control unit UNA₁ may decrease the value of the adjustable current source ISA₁ accordingly. Similarly, in response to a decrease in the current I_{D1}, the current detection and control unit UNA₁ may increase the value of the adjustable current source ISA₁ accordingly. Therefore, the current I_{AK1} (=I_{D1}+ISA₁) flowing through the 1^{st} driving stage ST₁ may be maintained at the constant value I_{SETA1} instead of changing with the voltage V_{AK1}.

During the rising period of the voltage V_{AK1} before the current I_{D1} reaches I_{SETA1}, the current detection and control unit UNA₁ turns on the adjustable current source ISA₁ and the current controller CCA₁ functions as a current limiter in the constant-current mode in which the current I_{AK1} (=IS_{ETA}1+I_{D1}) is clamped at a constant value of I_{SETA1}. When the current I_{D1} reaches I_{SETA1}, the current detection and control unit UNA₁ turns off the adjustable current source ISA₁ and the current controller CCA₁ switches to a cut-off mode in which the current I_{AK1} increases with the current I_{D1}.

During the falling period of the voltage V_{AK1} before the current I_{D1} drops I_{SETA1}, the current detection and control unit UNA₁ turns off the adjustable current source ISA₁ and the current controller CCA₁ operates in the cut-off mode in which the current I_{AK1} decreases with the current I_{D1}. When the current I_{D1} drops to I_{SETA1}, the current detection and control unit UNA₁ turns on the adjustable current source ISA₁ and the current controller CCA₁ functions as a current limiter in the constant-current mode in which the current I_{AK1} is clamped at a constant value of I_{SETA1}.

In FIG. 6, during the rising and falling periods of the voltage V_{BK1} when 0<V_{BK1}<V_{DROPB}, the second-type current controller CCB₁ is not completely turned on and operates as a voltage-controlled device in the linear mode in which the current I_{BK1} changes with the voltage V_{BK1} in a specific manner. For example, if the second-type current controller CCB₁ is implemented using MOS transistors, the relationship between the current I_{BK1} and the voltage V_{BK1} may correspond to the I-V characteristic of an MOS transistor when operating in the linear region.

During the rising period of the voltage V_{BK1} when V_{BK1}>V_{DROPB}, the current I_{BK1} reaches I_{SETB1}, and the current controller CCB₁ switches to the constant-current mode and functions as a current limiter. The voltage detection and control unit UNB₁ is configured to clamp the current I_{BK1} at I_{SETB1}.

During the rising period of the voltage V_{BK1} when V_{BK1}>V_{OFFB}, the voltage detection and control unit UNB₁ is configured to turn off the adjustable current source ISB₁ and the second-type current controller CCB₁ switches to the cut-off mode. In other words, the second-type current controller CCB₁ functions as an open-circuited device. During the falling period of the voltage V_{BK1} when V_{BK1}<V_{ONB}, the voltage detection and control unit UNB₁ is configured to turn on the adjustable current source ISB₁ and the current controller CCB₁ switches to the constant-current mode and functions as a current limiter, thereby clamping the current I_{BK1} at I_{SETB1}. The threshold voltage V_{ONB} is larger than or equal to the threshold voltage V_{OFFB}. In an embodiment, a non-zero hysteresis band (V_{ONB}−V_{OFFB}) may be provided in order to prevent the second-type current controller CCB₁ from frequently switching operational modes due to fluctuations in the voltage V_{BK1}.

In FIG. 7, when the 1^{st} driving stage ST₁ operates in a first phase with V1<V_{IN1}<V2, the luminance device A₁ is coupled in parallel with the luminance device B₁, as depicted on the left of FIG. 7. When the 1^{st} driving stage ST₁ operates in a second phase with V_{IN1}>V3, the luminance device A₁ is coupled in series to the luminance device B₁, as depicted on the right of FIG. 7.

In FIG. 8, during the rising period when the voltage V_{IN1} is low, the luminance device A₁, the luminance device B₁ and the path-controller D₁ remain off. During the rising period as the voltage V_{IN1} reaches a turn-on voltage V_{A1} which is the sum of the cut-in voltage for turning on the luminance device A₁ and the cut-in voltage for turning on the first-type current controller CCA₁, the first-type current controller CCA₁ and the luminance device A₁ are turned on, allowing the current I_{A1} to gradually increase with the voltage V_{IN1} until reaching I_{SETA1}; during the rising period as the voltage V_{IN1} reaches a turn-on voltage V_{B1} which is the sum of the cut-in voltage for turning on the luminance device B₁ and the cut-in voltage for turning on the second-type current controller CCB₁, the second-type current controller CCB₁ and the luminance device B₁ are turned on, allowing the current I_{B1} to gradually increase with the voltage V_{IN1} until reaching I_{SETB1}. With the path controller D1 still off, the current I_{SUM1} is equal to the sum of the current I_{A1} and the current I_{B1}, wherein the current I_{A1} is regulated by the current controllers CCA₁ and the current I_{B1} is regulated by the current controllers CCB₁. The value of the turn-on voltage V_{A1} may be equal to or different from that of the turn-on voltage V_{B1}. In other words, the current I_{SUM1} starts to increase at a voltage V1 which is equal to the smaller one among the turn-on voltage V_{A1} and the turn-on voltage V_{B1}.

During the rising period when the voltage V_{IN1} reaches V2 so that V_{BK1}=V_{OFFB}, the second-type current controller CCB₁ switches to the cut-off mode in which the current I_{B1} is directed towards the path-controller D₁, thereby turning on the path-controller D1. The current I_{SUM1} is equal to the current I_{B1} and I_{A1}, wherein both the current I_{A1} and the current I_{B1} are regulated by the first-type current controller CCA₁. As the current I_{B1} flows through the path-controller D₁, the current I_{D1} gradually increases with the voltage V_{IN1}. In response, the first-type current controller CCA₁ decreases the value of the adjustable current source ISA accordingly, so that the overall current I_{AK1} is still maintained at the constant value I_{SETA1}. When the value of the current source ISA₁ drops to zero at V_{IN1}=V3, the first-type current controller CCA₁ switches to the cut-off mode. The current I_{SUM1} is now regulated by the subsequent driving stage.

In FIG. 9, during the rising and falling periods of the voltage V_{CK} when 0<V_{CK}<V_{DROPC}, the third-type current controller CC_{N+1} is not completely turned on and operates as a voltage-controlled device in the linear mode in which the current I_{CK} changes with the voltage V_{CK} in a specific manner. For example, if the third-type current controller CC_{N+1} is implemented using MOS transistors, the relationship between the current I_{CK} and the voltage V_{CK} may correspond to the I-V characteristic of an MOS transistor when operating in the linear region. During the rising and falling cycles of the voltage V_{CK} when V_{CK}>V_{DROPC}, the current I_{CK} reaches I_{SETC}, and the third-type current controller CC_{N+1} switches to the constant-current mode and functions as a current limiter.

Similarly, the operation of the 2^{nd} to N^{th} driving stages ST2˜STN in the LED lighting device 104 may also be illustrated in FIGS. 5˜8, while the operation of the current controller CC_{N+1} in the (N+1)th driving stages ST_{N+1} of the LED lighting device 104 may also be illustrated in FIG. 9.

In the present invention, the charge storage units CH₁˜CH_{M} may be coupled in parallel with one or multiple luminescent devices among the luminescent devices A₁˜A_{N} and B₁˜B_{N}, respectively. The charge storage units CH₁˜CH_{M} can reduce the flicker of the LED lighting devices 101˜104, wherein M may be smaller than or equal to 2N.

In an embodiment when M=2N, each of the luminescent devices A₁˜A_{N} and B₁˜B_{N} is coupled in parallel with a corresponding charge storage unit. For illustrative purpose, FIG. 1 depicts the above-mentioned embodiment of N=2 and M=4 in which the LED lighting device 101 includes 4 luminescent devices A₁˜A₂ and B₁˜B₂ coupled in parallel with the charge storage units CH₁˜CH₄, respectively. However, the number and configuration of the charge storage units do not limit the scope of the present invention.

In an embodiment when M<2N, each of the luminescent devices B₁˜B_{N} is coupled in parallel with a corresponding charge storage unit. For illustrative purpose, FIG. 2 depicts the above-mentioned embodiment of N=2 and M=2 in which the LED lighting device 102 includes 4 luminescent devices A₁˜A₂ and B₁˜B₂ among which the luminescent devices B₁˜B₂ are coupled in parallel with the charge storage units CH₁˜CH₂, respectively. However, the number and configuration of the charge storage units do not limit the scope of the present invention.

In an embodiment when M<2N, the M charge storage units CH₁˜CH_{M} may be coupled in parallel with the luminescent devices which have the longest turn-on time among the luminescent devices A₁˜A_{N} and B₁˜B_{N}. For illustrative purpose, FIG. 3 depicts the above-mentioned embodiment of N=2 and M=2 in which the LED lighting device 103 includes 4 luminescent devices A₁˜A₂ and B₁˜B₂ among which the luminescent devices A₁ and B₁ are coupled in parallel with the charge storage units CH₁˜CH₂, respectively. However, the number and configuration of the charge storage units do not limit the scope of the present invention.

In an embodiment when M=1<2N, the charge storage unit CH₁ may be coupled in parallel with multiple luminescent devices which have the longest turn-on time among the luminescent devices A₁˜A_{N} and B₁˜B_{N}. For illustrative purpose, FIG. 4 depicts the above-mentioned embodiment of N=2 and M=1 in which the LED lighting device 104 includes 3 luminescent devices A₂ and B₁˜B₂ among which the luminescent devices B₁˜B₂ are coupled in parallel with the charge storage unit CH₁. However, the number and configuration of the charge storage units do not limit the scope of the present invention.

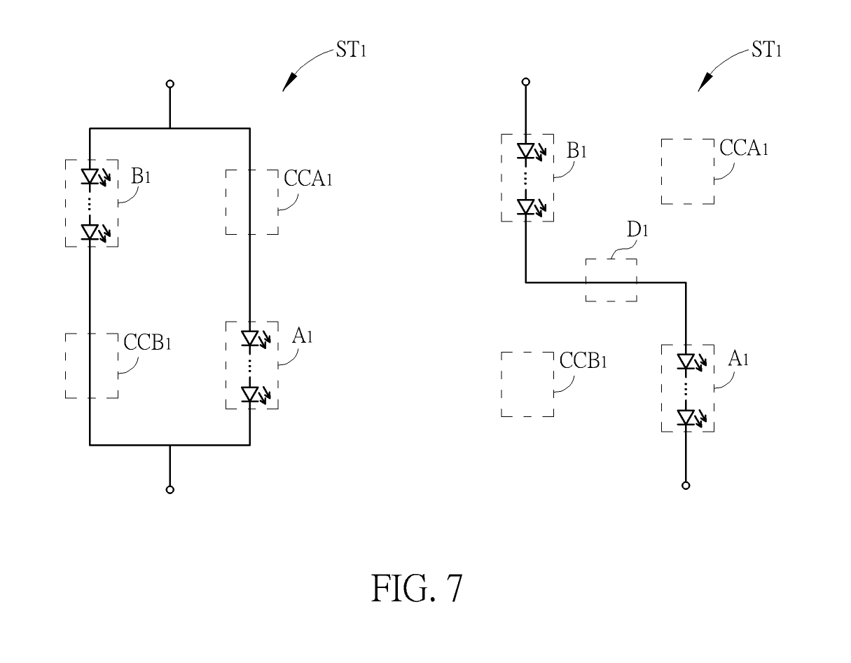

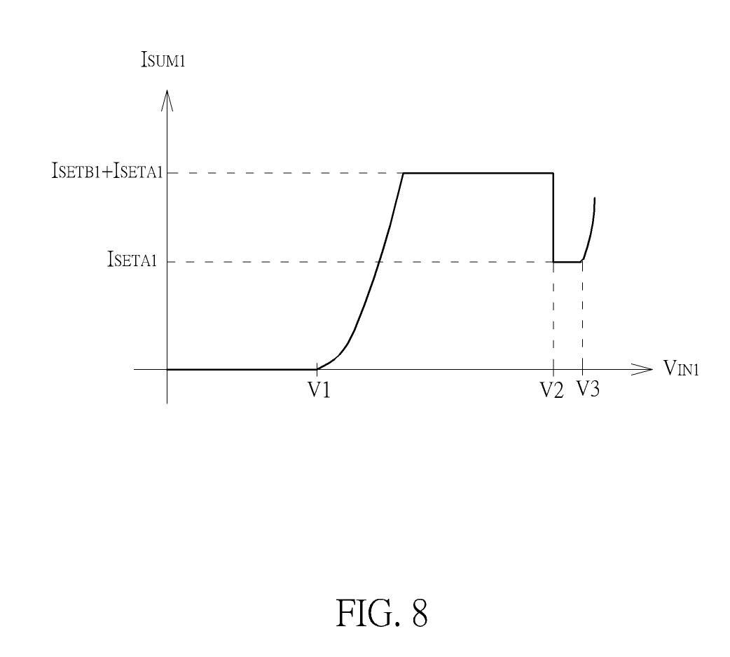

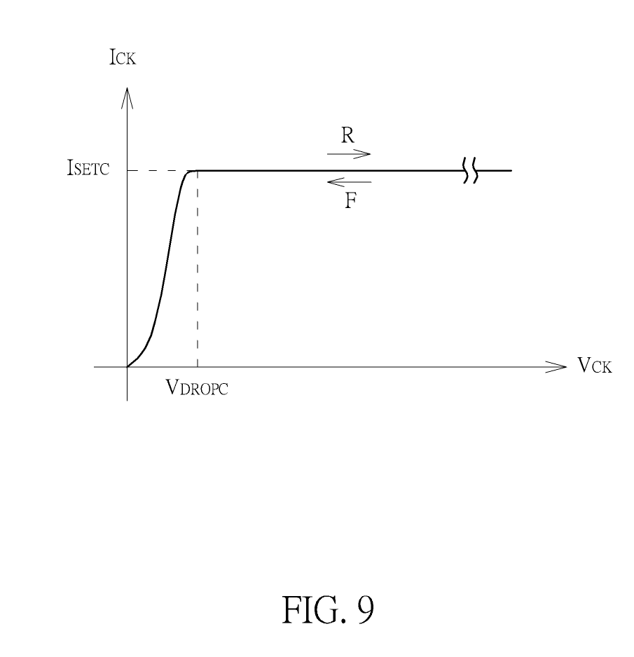

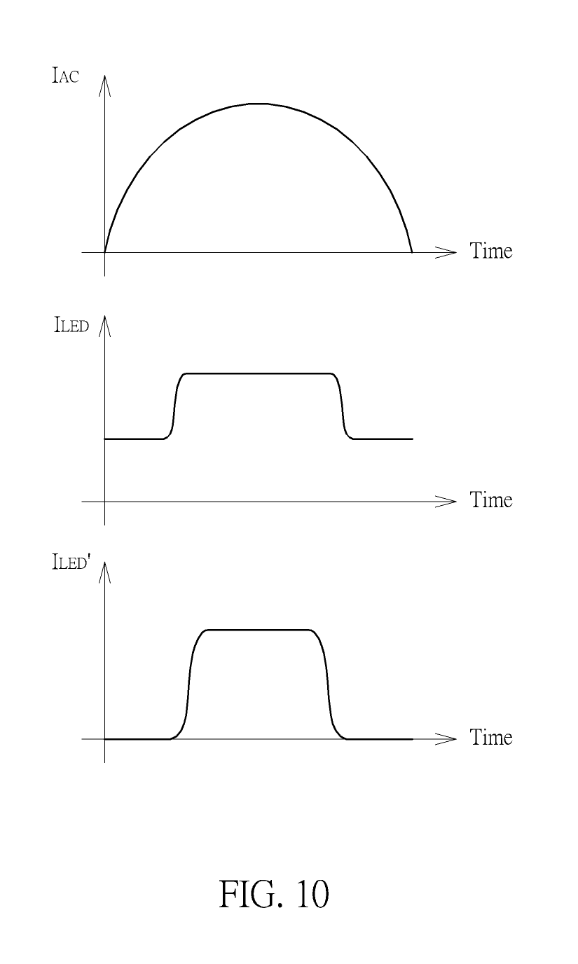

FIG. 10 is a diagram illustrating the current-time characteristic of the luminescent devices in the LED lighting devices 101˜104. The diagram in the middle of FIG. 10 represents the current-time characteristic of a luminescent device adopting a first configuration, and the diagram at the bottom of FIG. 10 represents the current-time characteristic of a luminescent device adopting a second configuration. In FIG. 10, I_{LED} represents the current flowing through the luminescent device adopting the first configuration and I_{LED} represents the current flowing through the luminescent device adopting the second configuration. The luminescent device adopting the first configuration is coupled in parallel with a corresponding charge storage unit, such as the luminescent device A₁, A₂, B₁ or B₂ in the LED lighting device 101, the luminescent device B₁ or B₂ in the LED lighting device 102, the luminescent device A₁ or B₁ in the LED lighting device 103, or the luminescent device B₁ or B₂ in the LED lighting device 104. The luminescent device adopting the second configuration is not coupled in parallel with any charge storage unit, such as the luminescent device A₁ or A₂ in the LED lighting device 102, the luminescent device A₂ or B₂ in the LED lighting device 103, or the luminescent device A₂ in the LED lighting device 104.

During the rising period before the rectified AC voltage V_{AC} becomes sufficiently large to turn on the luminescent device, the luminescent device adopting the second configuration remains in OFF state, while the luminescent device adopting the first configuration may be maintained in ON state by the energy discharged from the corresponding charge storage unit. The corresponding path controller is arranged to prevent the energy stored in the corresponding charge storage unit from being discharged through the corresponding current controller.

During the rising period or the falling period when the rectified AC voltage V_{AC} becomes sufficiently large, the luminescent device adopting the first configuration or the luminescent device adopting the second configuration may be maintained in ON state by the rectified AC voltage V_{AC}, which is now charging the corresponding charge storage unit.

During the falling period after the rectified AC voltage V_{AC} is no longer sufficiently large to turn on the luminescent device, the luminescent device adopting the second configuration remains in OFF state, while the luminescent device adopting the first configuration may still be maintained in ON state by the energy discharged from the corresponding charge storage unit. The corresponding path controller is arranged to prevent the energy stored in the corresponding charge storage unit from being discharged through the corresponding current control unit.

As depicted in FIG. 10, the introduction of the charge storage unit allows the luminescent device adopting the second configuration to have longer turn-on time than the luminescent device adopting the first configuration.

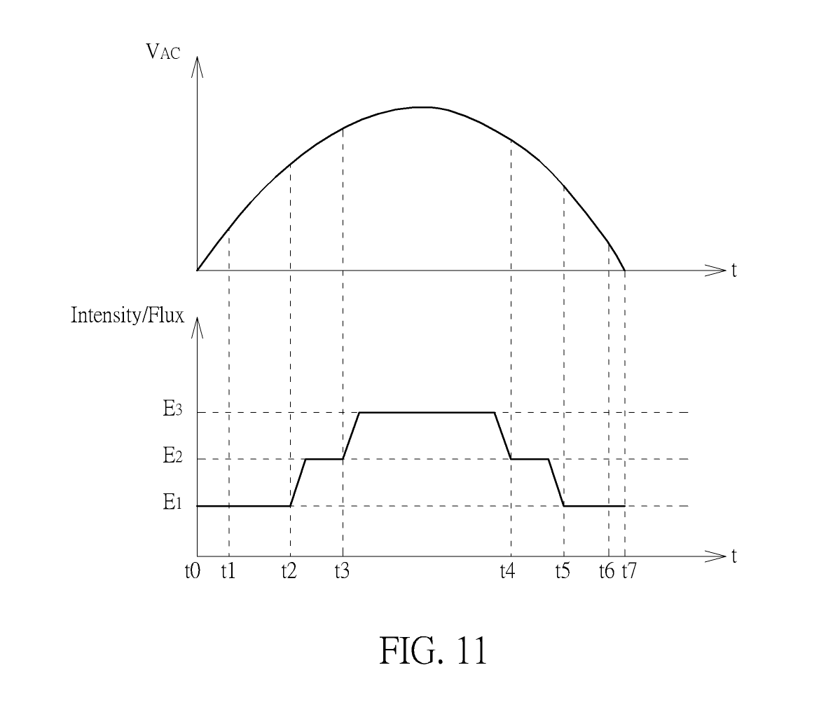

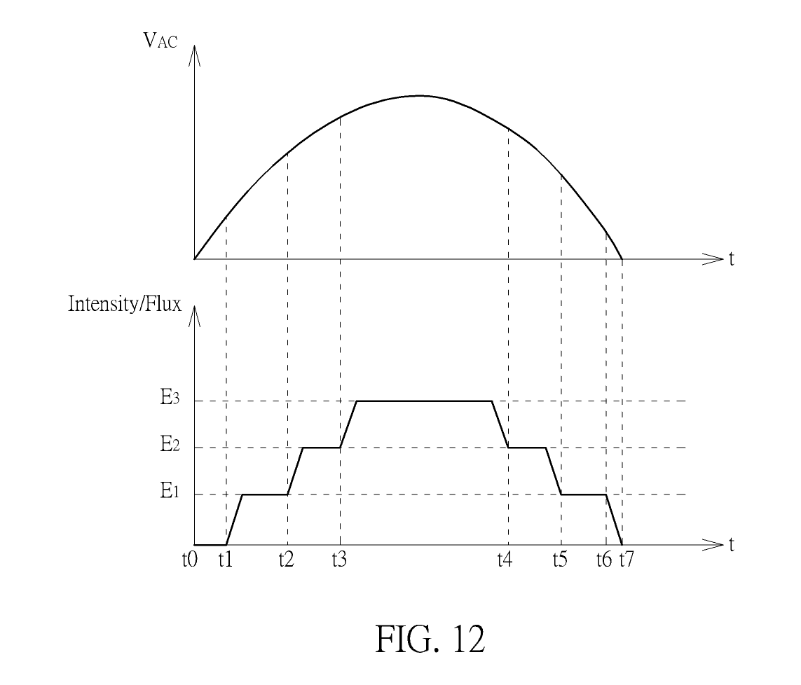

FIG. 11 is a diagram illustrating the overall operation of the LED lighting device 103 when two of the 4 luminescent devices A₁˜A₂ and B₁˜B₂ (N=2 and M=2) are coupled in parallel to respective charge storage units CH₁˜CH₂ or coupled in parallel to one communal charge storage unit CH₁. FIG. 12 is a diagram illustrating the overall operation of the LED lighting device 103 when no charge storage unit is adopted. E₁˜E₃ represent the overall intensity/flux of the present LED lighting device 103. It is to be noted that FIG. 12 is used as a comparison to FIG. 11 for illustrating how flicker can be improved using the present charge storage units as depicted in FIGS. 1˜4, but is by no means an intended operation of present invention.

Since the voltages V_{AK1}˜V_{AK2} and V_{BK1}˜V_{BK2} are associated with the rectified AC voltage V_{AC} whose value varies periodically with time, a driving cycle of t₀-t₇ is used for illustration, wherein the period between t₀-t₃ belongs to the rising period of the rectified AC voltage V_{AC} and the period between t₄-t₇ belongs to the falling period of the rectified AC voltage V_{AC}. The following Table 1 lists the operational modes of the luminescent devices A₁˜A₂ and B₁˜B₂ in accordance with the configuration depicted in FIG. 11. The following Table 2 lists the operational modes of the luminescent devices A₁˜A₂ and B₁˜B₂ in accordance with the configuration depicted in FIG. 12.

TABLE 1

| luminescent | t0~t1/ | t1~t2/ | t2~t3/ | |
|---|---|---|---|---|
| device | t6~t7 | t5~t6 | t4~t5 | t3~t4 |
| A₁ | ON (P) | ON (P) | ON (S) | ON (S) |
| B₁ | ON (P) | ON (P) | ON (S) | ON (S) |
| A₂ | OFF | ON (P) | ON (P) | ON (S) |
| B₂ | OFF | ON (P) | ON (P) | ON (S) |

TABLE 2

| luminescent | t0~t1/ | t1~t2/ | t2~t3/ | |
|---|---|---|---|---|
| device | t6~t7 | t5~t6 | t4~t5 | t3~t4 |
| A₁ | OFF | ON (P) | ON (S) | ON (S) |
| B₁ | OFF | ON (P) | ON (S) | ON (S) |
| A₂ | OFF | ON (P) | ON (P) | ON (S) |
| B₂ | OFF | ON (P) | ON (P) | ON (S) |

In FIG. 12 and Table 2, at the beginning of the rising period and at the end of the falling period, the rectified AC voltage V_{AC} is insufficient to turn on the luminescent devices A₁˜A₂ and B₁˜B₂.

Without the present charge storage units, the luminescent devices A₁˜A₂ and B₁˜B₂ remain in the OFF state between t0˜t1 and t6˜t7. Between t1˜t6, the luminescent devices A₁˜A₂ and B₁˜B₂ are sequentially turned on as the rectified AC voltage V_{AC} increases or decreases, and the 1^{st} driving stage ST₁ and the 2^{nd} driving stage ST₁ may operates in the first phase in which the two turned-on luminance devices are coupled in parallel (designated by “P” in Table 1 and Table 2) as depicted on the left of FIG. 7 or in the second phase in which the two turned-on luminance devices are coupled in series (designated by “S” in Table 1 and Table 2) as depicted on the right of FIG. 7. More specifically, the overall intensity/flux of the LED lighting device 103 varies stepwise and reaches E₃ between t3˜t4 when all the luminescent devices A₁˜A₂ and B₁˜B₂ operate in the ON state in the series configuration.

In FIG. 11 and Table 1, at the beginning of the rising period and at the end of the falling period, the rectified AC voltage V_{AC} is insufficient to turn on the luminescent devices A₁˜A₂ and B₁˜B₂. With the present charge storage units, the luminescent devices A₁ and B₁ may be kept in the ON state during the entire driving period between t0˜t7 regardless of the rectified AC voltage V_{AC}. More specifically, the overall intensity/flux of the present LED lighting device 103 may be maintained at E₁ between t0˜t1 and t6˜t7 when the rectified AC voltage V_{AC} is still small.

As well-known to those skilled in the art, LED flicker is periodic, with its waveforms characterized by variations in amplitude, average level, periodic frequency, shape, and/or duty cycle. Percent Flicker and Flicker Index are metrics historically used to quantify flicker, as represented by the following formula:

$$\begin{matrix}Percent Flicker = 100 \% \times \frac{MAX - MIN}{MAX + MIN} & ( 1 ) \\ Flicker Index = \frac{AREA 1}{AREA 1 + AREA 2} & ( 2 )\end{matrix}$$

In formula (1), MAX represents the maximum intensity/flux of the LED lighting devices 101˜104, while MIN represents the minimum intensity/flux of the LED lighting devices 101˜104. In formula (2), AREA1 represents the summation of intensity/flux within a duration of a driving cycle when the intensity/flux of the LED lighting devices 101˜104 is above its average, while AREA2 represents the summation of intensity/flux within a duration of the driving cycle when the intensity/flux of the LED lighting devices 101˜104 is below its average.

As can be seen in FIG. 11, the introduction of the charge storage units can increase MIN in formula (1) and AREA2 in formula (2), thereby lowering the Percent Flicker and Flicker Index of the LED lighting devices 101˜104.

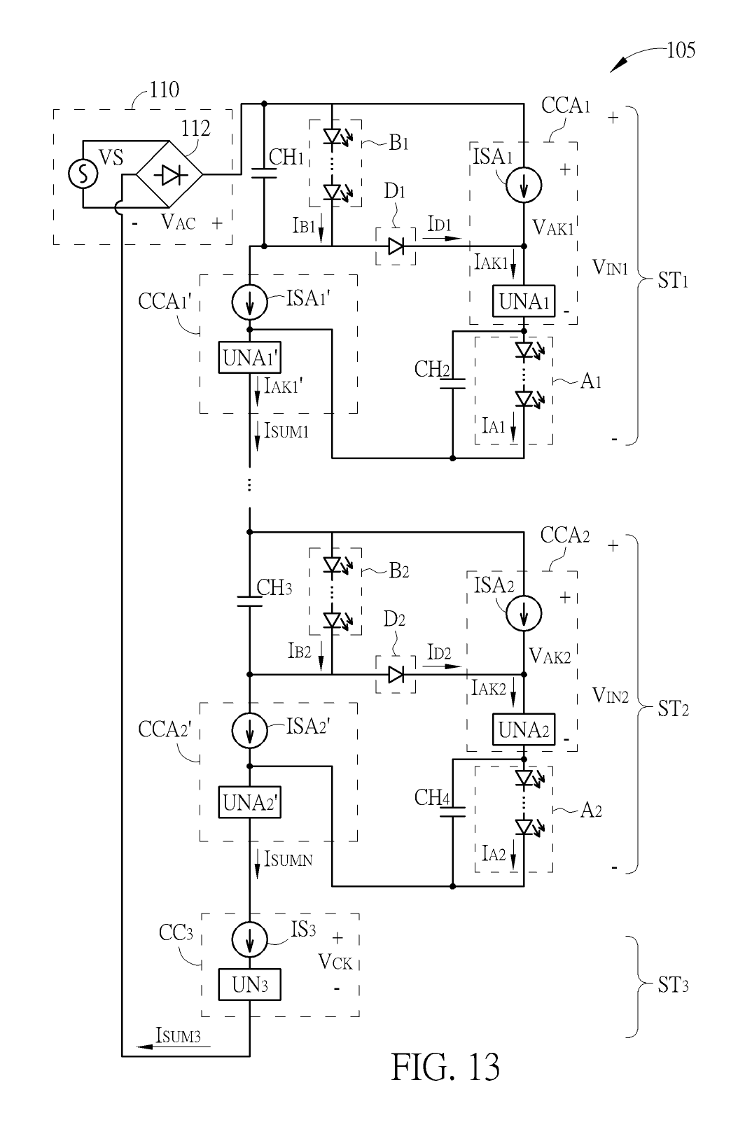

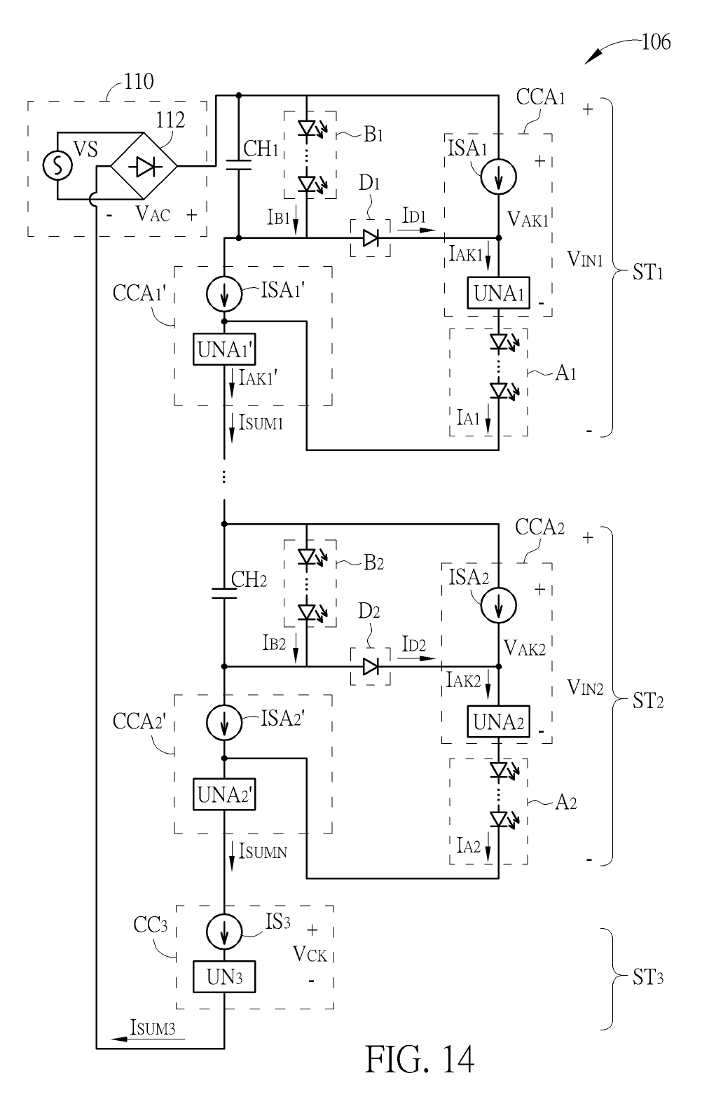

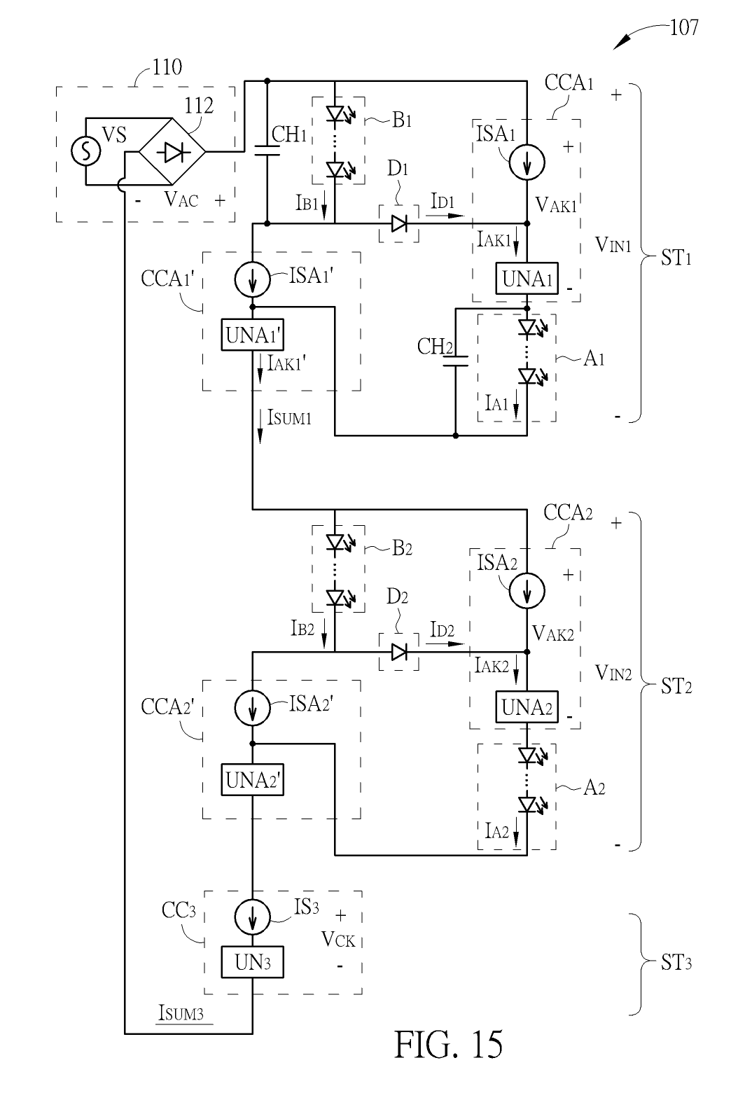

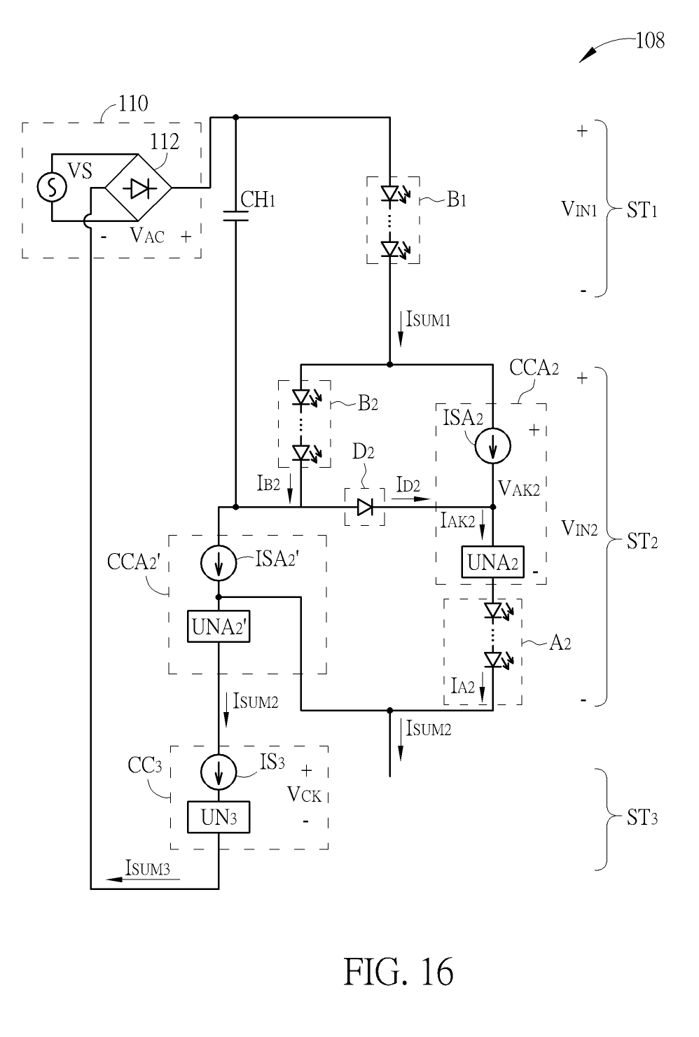

FIGS. 13˜16 are diagram of LED lighting devices 105˜108 according to other embodiments of the present invention. Similar to the LED lighting devices 101˜104 depicted in FIGS. 1˜4, each of the LED lighting devices 105˜108 also includes a power supply circuit 110 and (N+1) driving stages ST₁˜ST_{N+1} (N is a positive integer). However, the LED lighting devices 105˜107 differ from the LED lighting devices 101˜103 in that each of the 1^{st} to N^{th} driving stages ST₁˜ST_{N} includes a plurality of luminescent devices, a path controller, and two first-type current controllers. The LED lighting device 108 differs from the LED lighting device 104 in that each of the 2^{nd} to N^{th} driving stages ST₂˜ST_{N} includes a plurality of luminescent devices, a path controller, and two first-type current controllers.

Each first-type current controller in the LED lighting devices 105˜108 includes an adjustable current source and a current detection and control unit, and its I-V curve may also be shown in FIG. 5. In the first-type current controllers represented by CCA₁˜CCA_{N}, the current detection and control units UNA₁˜UNA_{N}, respectively coupled in series to the corresponding luminescent devices A₁˜A_{N} and the corresponding adjustable current sources ISA₁˜ISA_{N}, are configured to regulate the values of the adjustable current sources ISA₁˜ISA_{N} according the current I_{AK1}˜I_{AKN}, respectively. In the first-type current controller represented by CCA_{1′}˜CCA_{N′}, the current detection and control units UNA_{1′}˜UNA_{N′}, respectively coupled in series to the corresponding luminescent devices B₁˜B_{N} and the corresponding adjustable current sources ISA_{1′}˜ISA_{N′}, are configured to regulate the values of the adjustable current sources ISA_{1′}˜ISA_{N′} according the current I_{BK1}˜I_{BKN}, respectively.

With the above-mentioned multi-stage driving scheme, the present invention may turn on multiple luminescent devices flexibly using multiple current control units. With the above-mentioned charge storage units, the present invention may reduce luminous variation of the LED lighting device. Therefore, the present invention can provide an LED lighting device capable of improving the effective operational voltage range, the reliability and the flicker phenomenon.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting diode (LED) lighting device having multiple driving stages, comprising:
a first driving stage including:
a first luminescent device driven by a rectified alternative-current (AC) voltage for providing light according to first current;
a second luminescent device driven by the rectified AC voltage for providing light according to second current;
a first current controller coupled in series to the first luminescent device and configured to regulate the first current so that the first current does not exceed a first value;
a second current controller coupled in series to the second luminescent device and configured to regulate the second current so that the second current does not exceed a second value;
a first charge storage unit coupled in parallel with at least the first luminescent device and configured to discharge energy to the first luminescent device when the rectified AC voltage is insufficient to turn on the first luminescent device, thereby keeping the first luminescent device turned on; and
a first path-controller configured to conduct third current and comprising:
a first end coupled between the first luminescent device and the first current controller; and
a second end coupled to the second current controller; and
a second driving stage including:
a third current controller coupled in series to the first driving stage and configured to conduct fourth current and regulate the fourth current so that the fourth current does not exceed a third value.

2. The LED lighting device of claim 1, wherein the first charge storage unit is further configured to stop discharging the energy to the first luminescent device and start to be charged by the rectified AC voltage when the rectified AC voltage become sufficient to turn on the first luminescent device.

3. The LED lighting device of claim 1, further comprising:
a second charge storage unit coupled in parallel with the second luminescent device and configured to discharge energy to the second luminescent device when the rectified AC voltage is insufficient to turn on the second luminescent device, thereby keeping the second luminescent device turned on.

4. The LED lighting device of claim 1, further comprising:
a third driving stage coupled between the rectified AC voltage and the first driving stage and including:
a third luminescent device driven by the rectified AC voltage for providing light, wherein the first charge storage unit is coupled in parallel with the first luminescent device and the third luminescent device and configured to discharge energy to the first luminescent device and the third luminescent device when the rectified AC voltage is insufficient to turn on the first luminescent device and the third luminescent device, thereby keeping the first luminescent device and the third luminescent device turned on.

5. The LED lighting device of claim 4, wherein the first charge storage unit is further configured to stop discharging the energy to the first luminescent device and the third luminescent device and start to be charged by the rectified AC voltage when the rectified AC voltage become sufficient to turn on the first luminescent device and the third luminescent device.

6. The LED lighting device of claim 1, wherein:
during a rising period or a falling period of a rectified AC voltage when a voltage established across the first current controller does not exceed a first voltage, the first current controller operates in a first mode in which the first current changes with the voltage established across the first current controller;
during the rising period when the voltage established across the first current controller exceeds the first voltage but does not exceed a second voltage, the first current controller operates in a second mode in which the first current is maintained at the first value; and
during the rising period when the voltage established across the first current controller exceeds the second voltage, the first current controller operates in a third mode in which the first current controller is turned off.

7. The LED lighting device of claim 6, wherein:
during the falling period when the voltage established across the first current controller exceeds the second voltage but does not exceed a third voltage, the first current controller operates in the second mode in which the first current is maintained at the first value, and the third voltage is larger than or equal to the second voltage.

8. The LED lighting device of claim 1, wherein:
during a rising period or a falling period of the rectified AC voltage when the voltage established across the second current controller does not exceed a fourth voltage, the second current controller operates in a first mode in which the second current changes with the voltage established across the second current controller;
during the rising period or the falling period when the third current does not exceed the second value, the second current controller operates in a second mode in which the second current is maintained at the second value; and
during the rising period or the falling period when the third current exceeds the second value, the second current controller operates in a third mode in which the second current controller is turned off.

9. The LED lighting device of claim 1, wherein:
during a rising period or a falling period of the rectified AC voltage when the voltage established across the third current controller does not exceed a sixth voltage, the third current controller operates in a first mode in which the fourth current changes with the voltage established across the third current controller; and
during the rising period or the falling period when the voltage established across the third current controller exceeds the sixth voltage, the third current controller operates in a second mode in which the fourth current is maintained at the third value.

10. The LED lighting device of claim 1, wherein the first current controller includes:
a first adjustable current source configured to conduct fifth current; and
a first detection and control unit coupled in parallel with the first adjustable current and configured adjust the fifth current according to a voltage established across the first current controller.

11. The LED lighting device of claim 1, wherein the first current controller includes:
a first adjustable current source configured to conduct fifth current, and comprising:
a first end coupled to the first luminescent device; and
a second end coupled to the second luminescent device; and
a first detection and control unit coupled in series to the first adjustable current source and configured adjust the fifth current according to the first current and the second current.

12. The LED lighting device of claim 1, wherein the second current controller includes:
a second adjustable current source configured to conduct sixth current; and
a second detection and control unit configured adjust the sixth current according to the second current or the third current, and comprising:
a first end coupled to the second end of the first path-controller and the second adjustable current source; and
a second end coupled to the second luminescent device.

13. The LED lighting device of claim 1, wherein:
the first current controller includes:
a first adjustable current source configured to conduct fifth current; and
a first detection and control unit coupled in parallel with the first adjustable current source and configured adjust the fifth current according to a voltage established across the first current controller; and
the second current controller includes:
a second adjustable current source configured to conduct sixth current; and
a second detection and control unit configured adjust the sixth current according to the second current or the third current, and comprising:
a first end coupled to the second end of the first path-controller and the second adjustable current source; and
a second end coupled to the second luminescent device.

14. The LED lighting device of claim 1, wherein:
the first current controller includes:
a first adjustable current source configured to conduct fifth current, and comprising:
a first end coupled to the first luminescent device; and
a second end coupled to the second luminescent device; and
a first detection and control unit coupled in series to first adjustable current source and configured adjust the fifth current according to the first current and the second current; and
the second current controller includes:
a second adjustable current source configured to conduct sixth current; and
a second detection and control unit configured adjust the sixth current according to the second current or the third current, and comprising:
a first end coupled to the second end of the first path-controller and the second adjustable current source; and
a second end coupled to the second luminescent device.

15. The LED lighting device of claim 1, wherein the third current controller includes:
a third adjustable current source configured to conduct the fourth current; and
a third detection and control unit coupled in series to the third adjustable current source and configured to control the third adjustable current source according to the fourth current.

16. The LED lighting device of claim 1, wherein the first path-controller includes a diode, a diode-connected field effect transistor (FET), or a diode-connected bipolar junction transistor (BJT).

17. The LED lighting device of claim 1, wherein:
the first luminescent device is coupled in parallel with the second luminescent device when the first path-controller is turned off; and
the first luminescent device is coupled in series to the second luminescent device when the first path-controller is turned on.

18. The LED lighting device of claim 1, wherein:
when the first path-controller is turned off, the third current is zero, and the fourth current is equal to a sum of the first current and the second current; and
when the first path-controller is turned on, the first current, the second current, the third current and the fourth current is equal.
